(19) United States
(12) Patent Application Publication
(10) Pub. No.: US 2007/0030940 A1
(43) Pub. Date: Feb. 8, 2007

(54) Neutron beam interaction station and components

(76) Inventor: Willard H. Schmidt, Albuquerque, NM (US)

Correspondence Address: Willard H. Schmidt, 2015 Altez NE, Albuquerque, NM, 87112, US

(21) Appl. No.: 11/196,389

(22) Filed: Aug. 4, 2005

(51) Int. Cl. H05H 1/22

(52) U.S. Cl. 376/100

(57) ABSTRACT

In a Neutron Beam Interaction Station neutron particles are bound together to form new heavier nuclear particles. Neutron particle beams are focused in inhomogeneous magnetic fields between magnets in an array of magnets on either side of a neutron beam containment tube. The new particles have industrial, medical, and space exploration applications. The new particles are the basis for advanced nuclear power generating systems.

### BACKGROUND-DESCRIPTION OF PRIOR ART

This patent application is preceded by an application in my name titled “Multiple Neutron Beam Cyclotron System”. The function of that system is to provide focused, and very slow velocity neutron beams for the subject Neutron Beam Interaction Station. Neutrons have been studied since their discovery by James Chadwick in 1932. Many atoms and particles have magnetic moments. Stern and Gerlach measured the magnetic moment of silver atoms in a laboratory experiment in 1922, and verified the two quantum mechanical spin states for those atoms. Neutrons have a large negative magnetic moment, and it is important for the operation of this subject patent Neutron Beam Interaction Station.

### DRAWING FIGURES

FIG. 1 is a top cross section view of a set of magnets used in the Neutron Beam Interaction Station to separate and focus neutron beams in the containment tube.

FIG. 2 is a side cross section view of a magnet pair on either side of the neutron beam containment tube to create an inhomogeneous magnetic field.

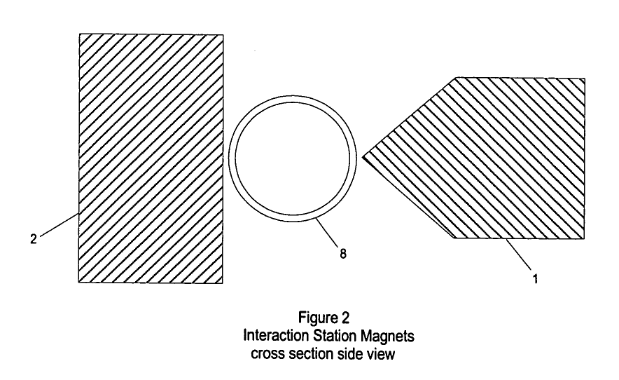

FIG. 3 is a side cross section view of two blunt face magnets used to create a uniform magnetic field across the neutron beam containment tube.

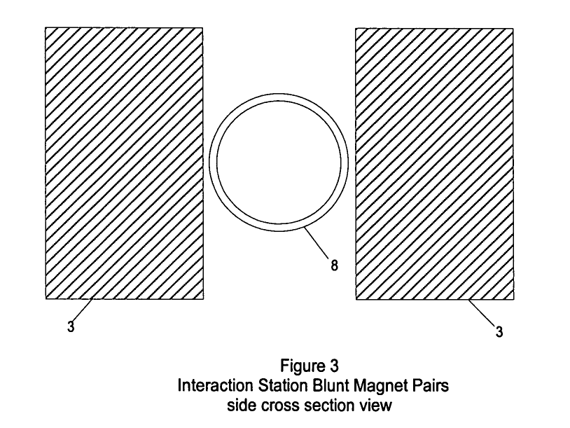

FIG. 4 is a top cross section schematic view of the Interaction Racetrack with the arrays of magnets surrounding the neutron beam containment tube.

FIG. 5 is a cross section side view of a cut-out magnet pair.

FIG. 6 is an isometric view of a pair of cut-out magnets.

### REFERENCE NUMERALS IN FIGURES

1. Knife edge magnet
2. Blunt face magnet
3. Flat face magnet pair
4. Neutron beam path with positive spin
5. Neutron beam path with negative spin
6. Bound particles path with positive spin
7. Bound particles path with negative spin
8. Neutron beam containment tube
9. Knife edge magnet with cut-out for containment tube
10. Blunt edge magnet with cut-out for containment tube
11. Cut-out in magnets for neutron beam containment tube

### DESCRIPTION OF INVENTION

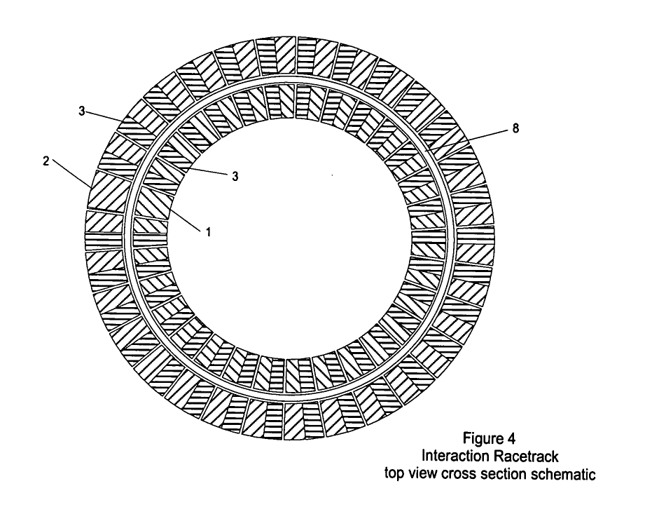

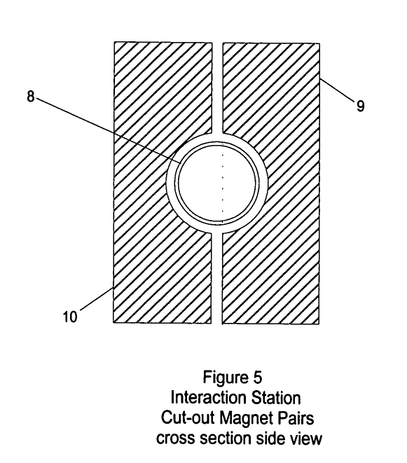

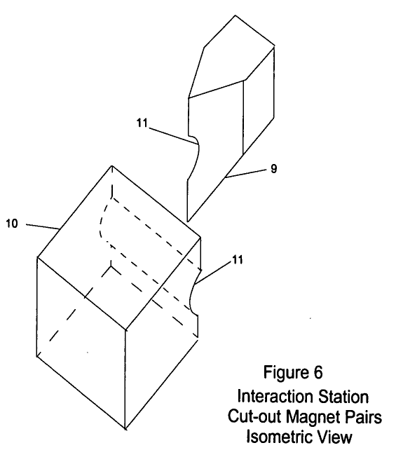

The Neutron Beam Interaction Station consists of arrays of magnets 1,2,3 on either side of a neutron beam containment tube 8. Neutron beam focusing magnets 1,2 are arranged in opposing pairs. A knife edge magnet 1 is opposite a blunt face magnet 2 across neutron containment tube 8 located between them. The position of these focusing magnet pairs 1,2 alternate in position around a geometrical configuration called a “racetrack”, as shown in FIG. 4. A blunt face magnet pair 3 is located between each of the focusing magnet pairs 1,2. FIG. 5 and FIG. 6 illustrate a design of focusing magnet pairs 9,10 called “cut-out” magnets that almost completely encase neutron tube 8. The cut-out magnets can be used in place of focusing magnets 1,2.

### OPERATION OF INVENTION

The purpose of the subject Neutron Beam Interaction Station is to receive neutrons that have been slowed to a very low velocity, and to focus the neutron beams so that interactions between the neutron particles can take place. Two neutrons bonded together form a new and heavier particle called Neu2, and these new particles are ultimately collected for future use.

Neutrons are admitted into the Interaction Racetrack, shown in FIG. 4, from the previously mentioned “Multiple Neutron Beam Cyclotron System” where they have been slowed to a very low velocity. Neutrons are injected into the neutron beam containment tube through two inlet ports so that they move in opposite directions through the neutron containment tube in the Interaction Racetrack. Neutron beams with velocities in opposite directions maximize use of the racetrack and increase the neutron interaction probability.

Neutrons are subject to a lateral force when they enter the inhomogeneous magnetic field between the respective magnetic poles of focusing magnets in the array around the Interaction Station racetrack. This force is due to an interaction between the magnetic field gradient between magnet pairs and the magnetic moments of neutrons in the containment tube. In the inhomogeneous magnetic field, neutrons are divided into two separate neutron beams of equal energy due to quantum mechanics. One beam has a nuclear spin in one direction and the other neutron beam has a nuclear spin in the opposite direction. This is a critical feature of the subject patent because it is necessary that neutron beams of opposite spin be focused together for neutron particle binding. Consequently, a possible problem with the Pauli Exclusion Principal, that might otherwise prevent particle binding, is avoided.

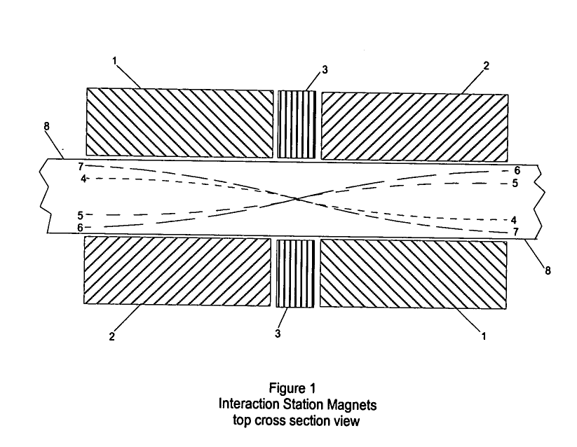

The method of focusing neutron particle beams in the Interaction Station is illustrated in FIG. 1. Neutron particles are injected into the racetrack neutron containment tube in a manner that directs neutrons in opposite directions in the containment tube. Neutrons are also forced to move in a lateral direction in the beam tube by interaction of the neutron magnetic moment with the magnetic field gradient between focusing magnet pairs in the racetrack. Neutron particles are forced toward the magnetic pole of a knife edge magnet or the magnetic pole of a blunt edge magnet, depending on the sign of the respective magnetic poles and the spin direction of the neutron particle. To promote neutron beam focusing and neutron particle interactions, the direction of the inhomogeneous magnetic field is reversed in successive sections of the racetrack magnet array. Neutron beam particles are forced to move in a zigzag fashion along the neutron containment tube. The resultant lateral shift in neutron beam direction causes the neutron beams to be focused as they move across the uniform magnetic field region of the flat face magnet pair located between the focusing magnet pairs. Neutron particle interaction occurs between the focused low velocity neutron beams with opposite spins, and particle binding produces new heavier Neu2 particles that are the end product of the Interaction Station.

### CONCLUSIONS AND SCOPE OF INVENTION

The Neutron Beam Interaction Station receives neutron particles from the Multiple Neutron Beam Cyclotron System. The binding together of neutron particles is facilitated by focusing neutron beams together by an array of magnets with inhomogeneous magnet fields. The new heavier Neu2 particles thus formed have industrial, medical, and space exploration applications. Neu2 particles can provide a new source of nuclear energy without the requirement for the heavy metals, uranium and plutonium, or the waste problems associated with them.

I claim:

1. A Neutron Beam Interaction Station that comprises an array of magnets on either side of a neutron beam containment tube in a closed geometric configuration.

2. The Neutron Beam Interaction Station of claim 1 comprising an inner and outer array of magnets on either side of neutron containment tube.

3. The Neutron Beam Interaction Station of claim 1 comprising a neutron containment tube around which are located arrays of magnets.

4. The Neutron Beam Interaction Station of claim 1 comprising blunt edge magnets and knife-edge magnets that operate in pairs to create an inhomogeneous magnetic field between them in a multiunit array.

5. The Neutron Beam Interaction Station of claim 1 comprising blunt edge and knife-edge magnet pairs on either side of neutron containment tube that have positions interchanged repetitively along the length of a neutron beam containment tube.

6. The Neutron Beam Interaction Station of claim 1 comprising blunt edge and knife-edge magnet pairs that have adjacent pole pieces cut out so that together they encase a neutron containment tube.

7. The Neutron Beam Interaction Station of claim 1 utilizing neutron particle beams that travel in opposite directions in a neutron beam containment tube and through an array of focusing magnets.

8. An alternating array of blunt edge and knife-edge magnets on either side of a neutron containment tube for the purpose of focusing neutron beams along the length of a neutron containment tube.

9. The interaction and binding together of neutrons in neutron beams focused by arrays of blunt and knife-edge magnet pairs.
